(19) United States
(12) Patent Application Publication
(10) Pub. No.: US 2026/0220046 A1
(43) Pub. Date: Jul. 30, 2026

(54) LOW OVERHEAD OBSERVATION OF MEMORY ACCESSES THROUGH CACHE COHERENCE MECHANISMS

(71) Applicant: MICROSOFT TECHNOLOGY LICENSING, LLC, Redmond, WA (US)

(72) Inventor: Derek T. CHIOU, Austin, TX (US)

(21) Appl. No.: 19/041,914

(22) Filed: Jan. 30, 2025

(51) Int. Cl. G06F 12/0815

(52) U.S. Cl. CPC G06F 12/0815

(57) ABSTRACT

Methods and apparatuses for increasing performance and reducing power consumption in computing systems that utilize cache coherence mechanisms to observe memory accesses and to perform memory management for cache memories are described. A cache coherence device may observe memory accesses over time by selectively controlling a set of cache lines to be sampled within a cache memory and then observing access notifications to the set of cache lines. In some cases, the cache coherence device controls a cache line to be sampled by obtaining the cache line in a coherence state other than an invalid state. By obtaining a cache line in the coherence state, the cache coherence device will be notified of attempted accesses to that cache line from processing units of the computing system.

### BACKGROUND

Many computing systems utilize a tiered memory hierarchy that allows for the movement of data across different tiers of the memory hierarchy between higher-cost, higher-performance memory (e.g., SRAM) and relatively lower-cost, lower-performance memory (e.g., magnetic or solid-state drives). The memory hierarchy often includes smaller, faster cache memories, which are typically embedded within processors or located in proximity to processors to reduce read/write data latency. Cache memories take advantage of the principal of locality as most computer programs do not access code and data uniformly. Instead, if a computer program accesses one memory address, then it is likely that the computer program will access the same memory address again or other nearby memory addresses. A cache hit occurs when a processor attempts to access data from a memory address and a cache memory has a copy of the data for the memory address. Conversely, a cache miss occurs when a processor attempts to access data from a memory address and the cache memory does not have a copy of the data for the memory address. Upon a cache miss, the data to be accessed must be fetched from a slower, farther away memory within the memory hierarchy and written into the cache memory, which negatively impacts performance. Typically, a contiguous block of memory corresponding to a cache block (e.g., a 64 B cache block or a 128 KB cache block) containing the missed memory address is written into the cache memory, such a cache block corresponds to a cache line within the cache memory.

### BRIEF SUMMARY

Systems and methods are provided for increasing performance and reducing power consumption in a computing system that utilizes cache coherence mechanisms to observe memory accesses and/or to perform memory management operations for cache memories within a cache memory hierarchy. Processing units load and store from/to memory to access data and to communicate. The ability to observe memory accesses performed by the computing system enables optimization of data access and communication within the computing system.

In some embodiments, the computing system comprises a multi-processing system in which two or more processing units are connected via a shared system bus to a shared main memory. The computing system may observe memory accesses to one or more cache memories from the two or more processing units over time and manage the data (e.g., associated with pages) that is stored within the one or more cache memories based on the observed memory accesses. A cache coherence device may observe the memory accesses by selectively controlling a set of cache lines to be sampled within the one or more cache memories and then observing access notifications or requests to the set of cache lines. In some cases, the cache coherence device controls a cache line to be sampled by obtaining the cache line in a coherence state other than an invalid state (e.g., the modified state of the MESI protocol states). By obtaining a cache line in any coherence state other than an invalid state, the cache coherence device will be notified of attempted accesses to that cache line from the two or more processing units of the computing system.

In some embodiments, a cache coherence device in communication with a cache memory samples a set of cache lines (e.g., 64 cache lines) within the cache memory by setting each cache line of the set of cache lines into a coherence state other than an invalid state. In one example, the cache coherence device initially samples an initial distribution (e.g., every 32 cache lines) of all the cache lines within the cache memory. Over time, the cache coherence device then aggregates the received access notifications for the set of cache lines and periodically updates the set of cache lines based on the aggregated access notifications. In one example, a first subset of cache lines (e.g., the ten least frequently accessed cache lines) out of the set of cache lines with the fewest number of access notifications are relinquished from being sampled or observed. In another example, a second subset of cache lines (e.g., the ten most frequently accessed cache lines) out of the set of cache lines with the greatest number of access notifications are used to identify additional cache lines to be sampled.

An alternative way to observe memory operations is to scan the access bits in page table entries that are set when a page is accessed. However, this approach is not efficient and takes a long time to perform. On many processors, translation lookaside buffers (TLBs) are not automatically kept coherent, which means that an access bit set in a TLB entry may be more up-to-date than its corresponding page table entry (PTE) in memory. Thus, the access bits in PTE entries may be out-of-date, especially for pages that are continuously accessed and, because of that, are not written back from the TLB to the PTE without an explicit flush. To ensure a particular PTE entry is up-to-date, if it's cached in the TLB, that TLB entry must be explicitly flushed, which can require the processor to enter privileged mode and then execute a TLB flush instruction. The TLB flush process, including the likely transition to privileged mode and back to user mode, takes considerable time to execute. Even if the PTE entries are current, scanning page table entries itself can consume a significant amount of time, for large numbers of pages. In contrast, the disclosed techniques that utilize cache coherence mechanisms to observe memory accesses provide low overhead observation of memory accesses.

According to some embodiments, the technical benefits of the systems and methods disclosed herein include reduced power and energy consumption during operation, improved battery life, and increased system performance. Other technical benefits can also be realized through various implementations of the disclosed technologies.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Like-numbered elements may refer to common components in the different figures.

FIGS. 1A-1E depicts embodiment of computing systems that include cache memories.

FIG. 2A depicts one embodiment of a networked computing environment in which the disclosed technology may be practiced.

FIG. 2B depicts one embodiment of various components of a computing system.

FIG. 3A depicts a flowchart describing one embodiment of a process for observing memory accesses using a cache coherence mechanism.

FIG. 3B depicts a flowchart describing an alternative embodiment of a process for observing memory accesses using a cache coherence mechanism.

### DETAILED DESCRIPTION

The technologies described herein improve the performance of computing systems that utilize cache coherence mechanisms to observe memory accesses and to perform memory management for caches within a cache memory hierarchy. In some embodiments, the computing system comprises a multi-processing system (e.g., a shared memory multi-processor system, a symmetric multi-processing system, or a heterogeneous multi-processor system) in which two or more processing units are connected via a shared system bus to a shared main memory with a corresponding memory space. A processing unit may comprise a hardware processor, an accelerator, a neural processing unit (NPU), a tensor processing unit (TPU), a central processing unit (CPU), a graphics processing unit (GPU), a Field-Programmable Gate Array (FPGA), or an application-specific integrated circuit (ASIC). An accelerator may comprise a dedicated hardware component or co-processor that is configured to perform specialized computational tasks, such as graphics processing, encryption, or machine learning inference. The multi-processing system may include one or more levels of cache memory. In one example, the computing system utilizes three levels of cache memory, with a level one (L1) cache memory (e.g., comprising a 50 KB memory), a level two (L2) cache memory (e.g., comprising a 500 KB memory), and a level three (L3) cache memory (e.g., comprising a 10 MB memory). In some cases, each processing unit has its own L1 and L2 caches and the L3 cache memory comprises a shared last-level cache (LLC) for the two or more processing units.

In some embodiments, a cache coherency protocol is utilized to ensure that all caches in the shared memory system maintain a consistent view of data. In one example, if the two or more processing units access data for the same memory address, cache coherency guarantees that each cache memory has up-to-date and synchronized copies of the shared data associated with the memory address. Some cache coherency protocols include bus snooping, in which each cache snoops or listens to all bus transactions on the shared system bus. In these cases, when one cache writes to a shared memory location, then the other caches can detect the write and either update or invalidate their own copies of the data accordingly. A Modified, Exclusive, Shared, Invalid (MESI) protocol may be used in computing systems employing bus snooping to maintain data consistency across multiple caches. With a MESI protocol, each cache line is assigned one of four possible states: either a modified state (the cache line has been modified such that the data differs from that in main memory and no other cache has a valid copy of the data), an exclusive state (the cache line matches the data in main memory and is not shared with any other cache), a shared state (the cache line matches the data in main memory and may be stored in other caches), or an invalid state (the cache line does not contain valid data). Some cache coherency protocols utilize a directory. In these cases, instead of broadcasting data updates, a directory is used to track which caches have copies of each memory block and when a write occurs, the directory informs the relevant caches of the data update. With coherent caches, the two or more processing units may exchange data without requiring explicit data transfers between the two or more processing units.

In some embodiments, a multi-processing system that includes processing units that participate in cache coherence observes memory operations over time and manages data stored within one or more cache memories based on the observed memory operations. In one example, a processing unit within the multi-processing system comprises a cache coherence device (e.g., a CXL. cache device) that manages a coherence protocol and controls access to memory and cache resources for the multi-processing system. The cache coherence device may observe memory operations by selectively controlling a set of cache lines to be sampled within a cache memory and then observing access notifications or requests to the set of cache lines. In some cases, the cache coherence device controls a cache line to be sampled by obtaining the cache line in a coherence state other than an invalid state (e.g., the modified state of the MESI protocol states). By obtaining a cache line in a valid coherence state, the cache coherence device will be notified of attempted accesses to that cache line from processing units of the multi-processing system. In one example, a cache line may be obtained or sampled by the cache coherence device by marking the cache line as being in a modified state, an exclusive, or a shared state.

In some embodiments, a cache coherence device controls a cache line to be sampled by taking an exclusive copy of the cache line. Setting the cache line of a cache memory into an exclusive state means that the cache line is not valid in any other cache memory. In some cache coherent implementations (e.g., utilizing CXL. cache devices), a cache coherence device that caches a cache line in an exclusive state does not necessarily have a copy of the data for the cache line. In such cases, the cache coherence device can relinquish the exclusive state without having to return the data, which has the technical benefit of the cache coherence device not needing to obtain and/or save a copy of the data, thereby saving bandwidth and the cache coherence device needing to store the data locally. Furthermore, dynamically obtaining and relinquishing cache lines that are sampled does not require remapping of pages, thereby saving the overhead of remapping pages.

In other embodiments, the cache coherence device controls a cache line to be sampled by taking a shared copy of the cache line. In this case, the cache coherence device will be notified of requested stores to the cache line. Upon detection that a cache line that is being sampled was accessed by a processing unit of the multi-processing system, the cache coherence device may relinquish control of that cache line within the cache memory. A technical benefit of relinquishing control of the sampled cache line is that the cache coherence device won't be flooded with access requests, thereby eliminating the need for the cache coherence device to filter subsequent requests to access the cache line. After the cache coherence device has relinquished control of a cache line, the cache coherence device will not receive notification of subsequent accesses to the cache line until the cache line is reobtained by the cache coherence device.

In some cases, the sampling of specific cache lines within a cache memory is accomplished without writing data to the cache memory. A cache coherence device may obtain the cache lines to be sampled using one or more bus operations without writing data to the cache memory. A bus operation may request exclusive access to a particular cache line. In one example, the cache coherence device comprises a CXL. cache device and the bus operation corresponds to issuance of a “RdOwnNoData” CXL command.

In some embodiments, a cache coherence device samples a set of cache lines (e.g., 100 cache lines) within a cache memory by setting each cache line of the set of cache lines into a coherence state other than an invalid state. In one example, the cache coherence device samples a uniform distribution (e.g., every 32 cache lines) of all the cache lines within the cache memory. In another example, the cache coherence device samples a set of cache lines within a cache memory based on access statistics for the set of cache lines. In these cases, the cache lines within the cache memory with the most frequent access may continue to be sampled while other cache lines that are infrequently accessed are relinquished.

Over time, the cache coherence device may collect the access requests for the set of cache lines and then update the set of cache lines based on the collected access requests. In one example, a first subset of cache lines (e.g., the ten least frequently accessed cache lines) out of the set of cache lines with the fewest number of access notifications are relinquished from being sampled or observed. In another example, a second subset of cache lines (e.g., the ten most frequently accessed cache lines) out of the set of cache lines with the greatest number of access notifications are used to identify additional cache lines to be sampled. For every cache line in the second subset of cache lines, two or more additional cache lines that are within a threshold distance (e.g., that are within ten cache lines) of the cache line are obtained by the cache coherence device.

In some embodiments, a cache coherence device determines a set of cache lines in a cache memory to be sampled, sets each cache line of the set of cache lines to a coherence state (e.g., to an exclusive state) other than an invalid state, aggregates a set of access notifications for the set of cache lines, identifies a set of cold cache lines of the set of cache lines based on the set of access notifications, and then moves data out of the cache memory or causes data for the set of cold cache lines to be moved out of the cache memory in response to identifying the set of cold cache lines as being cold or infrequently accessed cache lines. Technical benefits of identifying the set of cold cache lines based on the sampled set of access notifications include improved system performance and reduced power consumption as cache memory resources are more effectively utilized.

In some embodiments, a cache coherence device samples a set of cache lines to identify portions of a cache memory that are hot (or most frequently accessed) and to identify portions of the cache memory that are cold (or infrequently accessed). In response to determining the portions of the cache memory that are cold, the cache coherence device causes the memory blocks corresponding to those cache lines to be moved to main memory or to a cache memory that is closer to the main memory. In some embodiments, machine learning techniques are utilized to identify the portions of the cache memory that are cold and should be removed from the cache memory.

In some embodiments, a cache coherence device samples a set of cache lines to identify a first set of pages that are hot (or frequently accessed) and/or a second set of pages that are cold (or infrequently accessed). In one example, a main memory is divided into pages of a page size (e.g., 4 KB pages) and cache lines are associated with a cache block size (e.g., 128 B of data). If the page size is 4 KB and the cache block size is 128 B, then a page of data maps to 32 cache lines. In response to determining a second set of pages that are cold, the cache coherence device causes those pages to be moved to main memory or to a cache memory that is closer to the main memory.

In some embodiments, the cache coherence device adjusts the frequency of sampling cache lines based on the portions of the cache memory that are found to be hot and the portions of the cache memory that are found to be cold. The sampling rate and the number of cache lines sampled may be increased within the portions of the cache memory that are found to be hot.

In some embodiments, a cache coherence device samples a set of cache lines for a cache memory to identify memory locations that are accessed by a circular buffer and/or its producer/consumer pointers. The cache coherence device can then determine when the producer/consumer pointers are accessed and only poll or sample on them rather than polling on producer/consumer pointers before they are written which will cause cache thrashing.

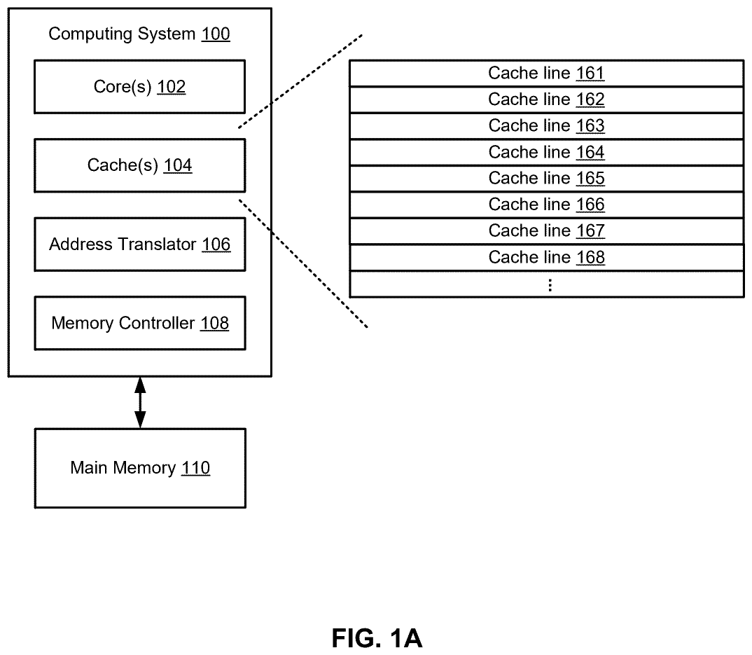

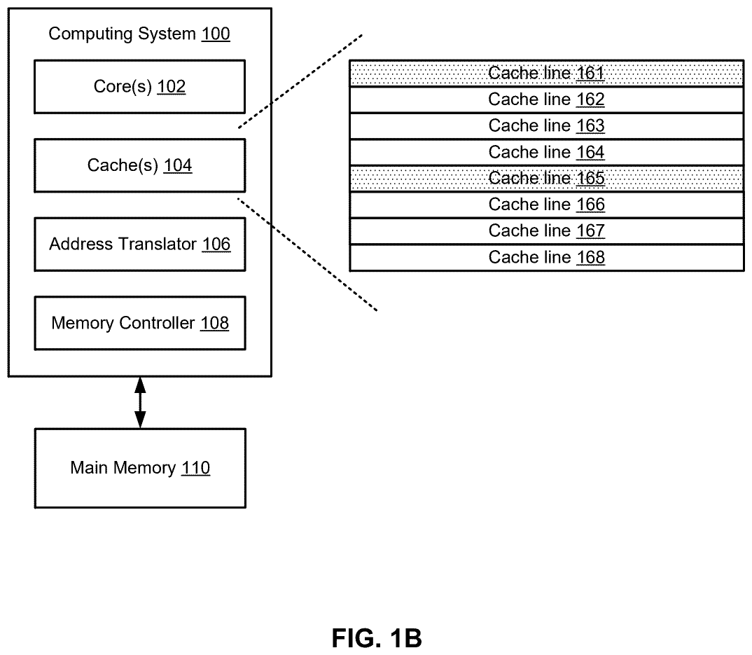

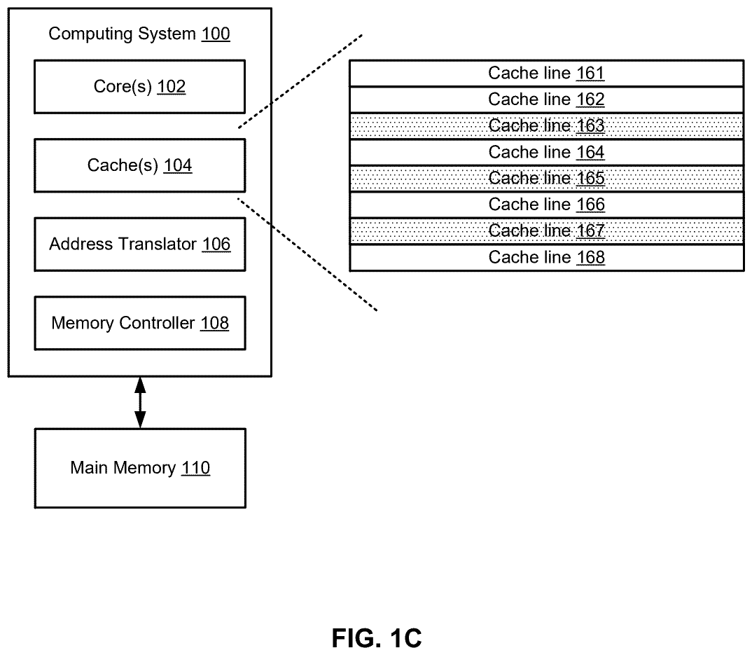

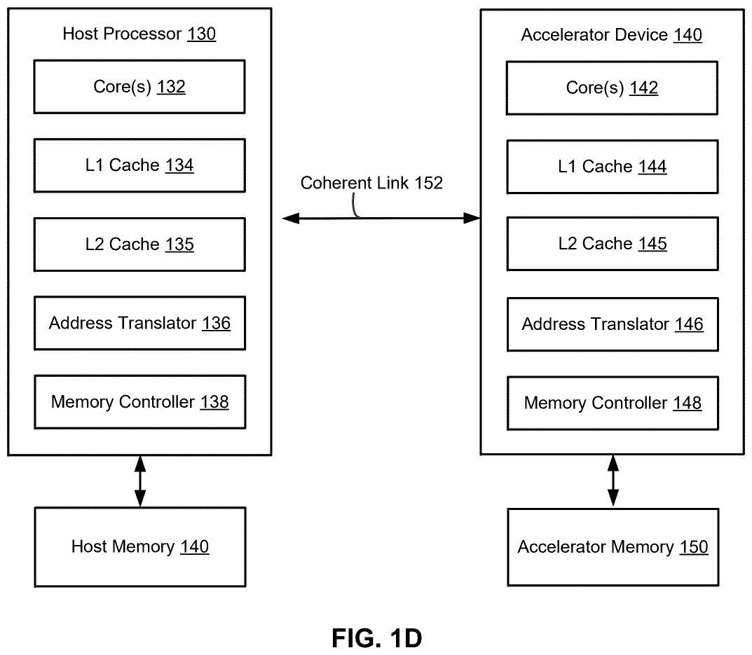

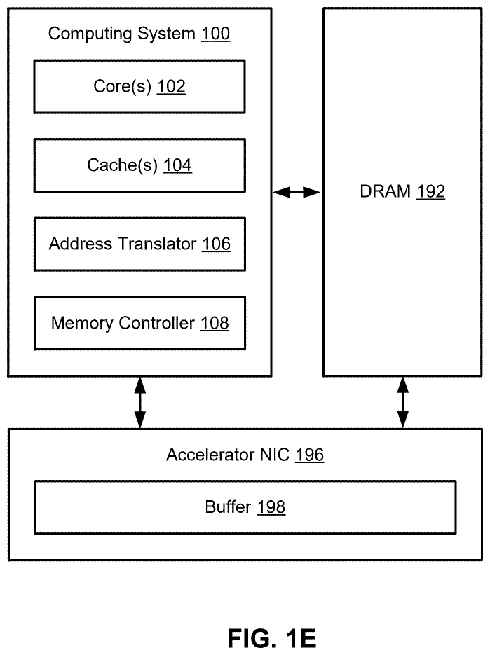

FIG. 1A depicts one embodiment of a computing system 100 in communication with a main memory 110. The computing system 100 includes one or more cores 102, one or more caches 104, an address translator 106, and a memory controller 108. A cache of the one or more caches 104 includes a plurality of cache lines including cache lines 161-168. The one or more cores 102 may comprise multiple processor cores that are in communication with each other via a coherent link. In some cases, the computing system 100 is coupled to an accelerator device, such as accelerator device 140 in FIG. 1D, using a coherent link, such as a Compute Express Link (CXL).

CXL utilizes elements of Peripheral Component Interconnect Express (PCI Express or PCIe) to enable communication between various devices, such as processors (e.g., CPUs) and accelerators (e.g., GPUs, FPGAs, tensor and vector processor units, and machine learning accelerators). With a CXL framework, CXL. cache may be used to manage cache coherence across different devices, particularly when dealing with heterogeneous systems where CPUs, GPUs, FPGAs, and other accelerators share memory resources. CXL. cache allows for a coherent memory space where both processors and accelerators (e.g., CXL devices) interact with a shared memory.

The one or more cores 102 are configured to execute instructions and process data stored in main memory 110 and/or cached in one or more caches 104. In some cases, the one or more cores 102 implement or embody a general purpose or special purpose processor, such as a graphics processor, a digital signal processor, or a vector/tensor processor. The address translator 106 may translate virtual memory addresses to physical memory addresses for the main memory 110. If a physical address points to the main memory 110, then the memory controller 108 processes the memory request on behalf of a requesting core 102 and may store the data using one or more cache lines of the one or more caches 104.

Each of the cache memories of the one or more caches 104 may be classified as direct mapped, fully associative, or set associative. A direct mapped cache memory provides a type of cache memory organization in which each main memory block can only be mapped to one specific cache line. A fully associative cache memory provides the most flexible form of cache memory organization in which any block from main memory may be stored in any cache line. The direct mapped approach contrasts with more complex cache memory organizations such as set-associative or fully associative caches, in which a main memory block can be placed in more than one cache location, thereby reducing conflict misses at the cost of increased hardware complexity and potentially slower access times due to the need for comparison across multiple cache lines. A set associative cache memory provides a type of cache memory organization between a direct mapped cache memory and a fully associative cache memory. A direct mapped cache memory can be viewed as one-way set associative and a fully associative cache memory with m blocks can be viewed as m-way set associative. A cache tag (or tag) may be used with each cache line to map a memory address to its corresponding cache line. In one example, when a memory address is accessed, the tag part of the address is compared to the tags stored in a cache memory to determine if the data is in the cache memory (cache hit) or not (cache miss).

The one or more caches 104 may temporarily store data that the one or more cores 102 are using, thereby minimizing the time it takes to retrieve data compared to fetching the data from main memory. In some cases, each cache of the one or more caches 104 consists of a cache array and a cache directory. A memory controller 108 may control the movement of data and instructions between the one or more cores 102, the one or more caches 104, and the main memory 110. The one or more caches 104 may comprise a dynamic random access memory (DRAM), a synchronous dynamic random access memory (SDRAM), a static random access memory (SRAM), a ferroelectric random access memory (FeRAM), a magnetic random access memory (MRAM), and/or a resistive random access memory (RRAM). In one example, the main memory 110 comprises DRAM and the one or more cache memories comprise SRAM. The cache directory may store the coherency states of the cached data.

FIG. 1B depicts the computing system 100 of FIG. 1A in which two cache lines 161 and 165 are being sampled. In one example, the memory controller 108 acting as a cache coherence device sets the cache lines 161 and 165 into a coherence state other than an invalid state (e.g., into an exclusive state). After the cache lines 161 and 165 have been obtained for observation, access notifications for the cache lines 161 and 165 will be aggregated by the memory controller 108 over a sampling time period (e.g., over 30 ms). After the sampling time period, the memory controller 108 may update the cache lines being sampled.

FIG. 1C depicts the computing system 100 of FIG. 1A in which the cache line 161 has been released from sampling and two additional cache lines 163 and 167 are being sampled and memory access notifications for all three cache lines are aggregated by the memory controller 108. In one embodiment, the cache line 161 was relinquished by the memory controller 108 because a memory access notification for the cache line 161 did not occur during the sampling time period that cache line 161 was being sampled. The two additional cache lines 163 and 167 may have been identified due to greater than a threshold number of access notifications (e.g., more than two access notifications) being received by the memory controller 108 for the cache line 165 over the sampling time period.

In one embodiment, an initial spacing between cache lines to be sampled may comprise a first spacing (e.g., every five cache lines) and then a second spacing from a hot cache line may comprise a second spacing (e.g., two cache lines away) that is less than the first spacing. In one example, an initial cache line spacing in FIG. 1B comprises an initial spacing of five cache lines and the second spacing in FIG. 1C comprises a second spacing of two cache lines as the cache lines 163 and 167 are two cache lines away from the cache line 165.

FIG. 1D depicts a host processor 130 in communication with an accelerator device 140 via a coherent link 152. The host processor 130 includes one or more cores 132, an L1 cache 134, an L2 cache 135, an address translator 136, and a memory controller 138. The host processor 130 is in communication with a host memory 140. The accelerator device 140 includes one or more cores 142, an L1 cache 144, an L2 cache 145, an address translator 146, and a memory controller 148. The accelerator device 140 is in communication with an accelerator memory 150. The host processor 130 is coupled to the accelerator device 140 via the coherent link 152, such as a Compute Express Link (CXL) link. The one or more cores 132 are configured to execute instructions and process data stored in host memory 140, cached in caches 134 and 135, and/or stored in the accelerator memory 150. Similarly, the one or more cores 142 are configured to execute instructions and process data stored in accelerator memory 150, cached in caches 144 and 145, and/or stored in the host memory 140. In some cases, the host processor 130 corresponds to the computing system 100 in FIG. 1A.

FIG. 1E depicts one embodiment of the computing system 100 in communication with an accelerator network interface controller (NIC) 196 and a DRAM 192. The DRAM 192 may be used to store instructions and data to be used by the one or more cores 102 of the computing system 100. The buffer 198 may comprise a cache memory within the accelerator NIC 196.

In some embodiments, the accelerator NIC 196 with its buffer 198 may save bandwidth by receiving data from an external network and then instead of writing the data to the DRAM 192, the accelerator NIC 196 may locally cache the data in the buffer 198 and then take an exclusive line for the one or more caches 104 so that when the one or more cores 102 requires data from the DRAM 192, the accelerator NIC 196 will be notified and can instead provide the requested data directly to the one or more cores 102 from the buffer 198. In this case, the buffer 198 may act as a cache for the DRAM 192 and eliminate the need to transfer the data to the DRAM 192. A technical benefit of utilizing the buffer 198 as a cache for the DRAM 192 is that memory bandwidth is conversed and power is reduced as large amounts of data are not transferred to and from the DRAM 192.

In one embodiment, the buffer 198 comprises a 512 MB cache and instead of passing through 64 MB of data through the accelerator NIC 196 to the DRAM 192, the 64 MB of data is stored locally in the buffer 198 and the accelerator NIC 196 requests a set of cache lines corresponding to where the 64 MB of data would be stored within the DRAM 192 to be set into an exclusive state. The accelerator NIC 196 takes exclusive control of the set of cache lines without transferring the 64 MB of data. When the one or more cores 102 within the computing system 100 attempt to access the set of cache lines from the DRAM 192, the accelerator NIC 196 is notified of the request and transfers the 64 MB of data from the buffer 198 to the one or more caches 104.

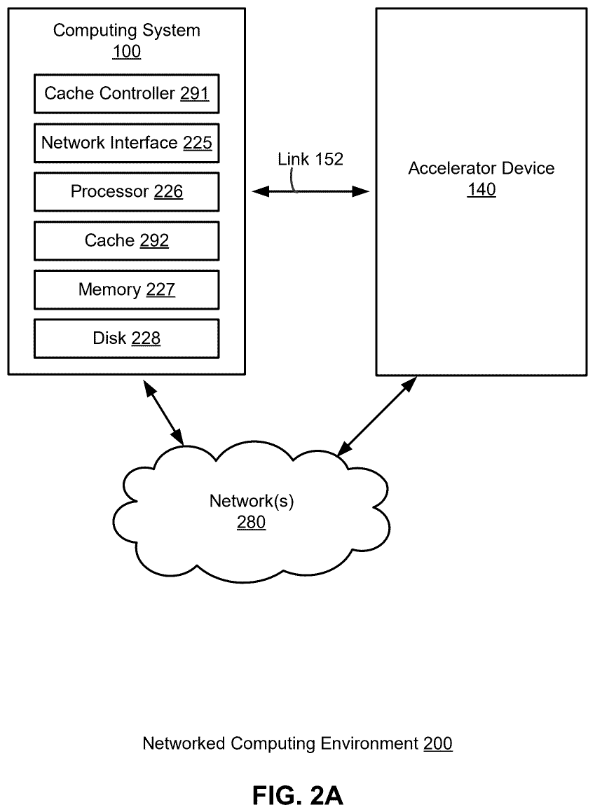

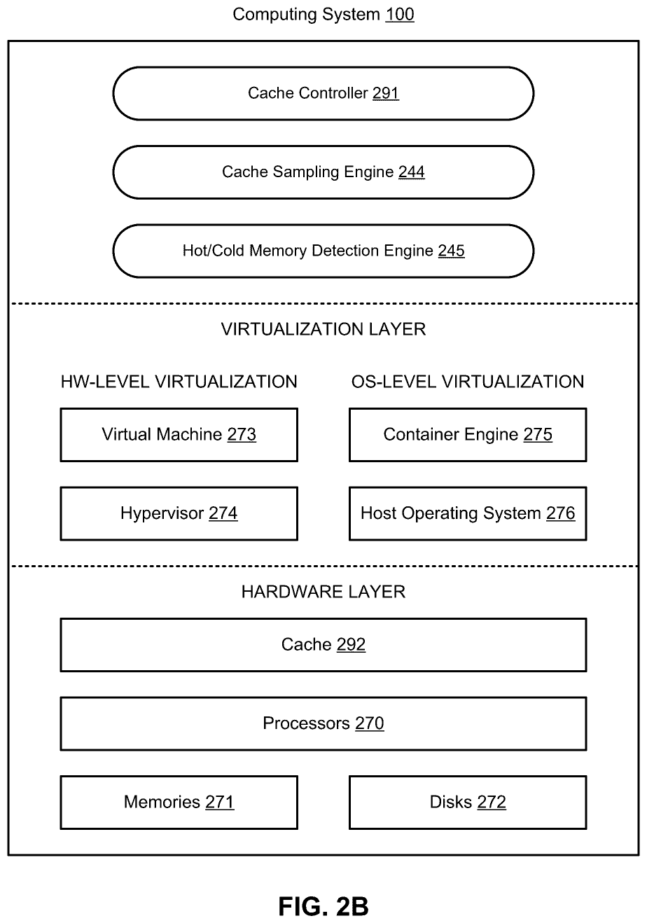

FIG. 2A depicts one embodiment of a networked computing environment 200 in which the disclosed technology may be practiced. The networked computing environment 200 includes a computing system 100 and an accelerator device 140 in communication with each other via one or more networks 280 and a link 152. In some cases, the networked computing environment 200 corresponds with or provides access to a cloud computing environment providing Software-as-a-Service (Saas) or Infrastructure-as-a-Service (IaaS) services. The one or more networks 280 allow computing devices and/or storage devices to connect to and communicate with other computing devices and/or other storage devices. In some cases, the networked computing environment 200 includes other computing and storage devices interconnected through the one or more networks 280. As examples, the other computing devices include a mobile computing device, a non-mobile computing device, a server, a workstation, a laptop computer, a tablet computer, a desktop computer, or an information processing system. The other storage devices include a storage area network storage device, a networked-attached storage device, a hard disk drive, a solid-state drive, a data storage system, or a cloud-based data storage system. In some cases, the one or more networks 280 include a cellular network, a mobile network, a wireless network, a wired network, a secure network such as an enterprise private network, an unsecure network such as a wireless open network, a local area network (LAN), a wide area network (WAN), the Internet, or a combination of networks.

In some embodiments, the computing devices within the networked computing environment 200 comprise real hardware computing devices or virtual computing devices, such as one or more virtual machines. In some embodiments, the storage devices within the networked computing environment 200 comprise real hardware storage devices or virtual storage devices, such as one or more virtual disks. In one example, the real hardware storage devices include non-volatile and volatile storage devices.

As depicted in FIG. 2A, the computing system 100 includes a cache controller 291, cache 292, network interface 225, processor 226, memory 227, and disk 228 all in communication with each other. The network interface 225, processor 226, memory 227, cache 292, and disk 228 may comprise real components and/or virtualized components. Network interface 225 allows the computing system 100 to connect to the one or more networks 280. In one example, the network interface 225 comprises a wireless network interface and/or a wired network interface. Processor 226 allows the computing system 100 to execute computer readable instructions stored in memory 227 in order to perform processes described herein. In one example, the processor 226 comprises one or more processing units, such as one or more CPUs, one or more GPUS, and/or one or more NPUs. In one example, the memory 227 comprises one or more types of memory (e.g., RAM, SRAM, DRAM, EEPROM, Flash). In one example, the disk 228 comprises a hard disk drive and/or a solid-state drive. Memory 227 and disk 228 may comprise hardware storage devices.

FIG. 2B depicts one embodiment of various components of the computing system 100 in FIG. 2A. As depicted, the computing system 100 includes hardware-level components and software-level components. The hardware-level components may include one or more cache 292, one or more processors 270, one or more memories 271, and one or more disks 272. The one or more processors 270 may include one or more processing units, such as one or more CPUs, one or more GPUs, and/or one or more NPUs. The one or more memories 271 may comprise one or more types of memory (e.g., RAM, SRAM, DRAM, EEPROM, Flash). The one or more disks 272 may include a hard disk drive and/or a solid-state drive. Both the one or more memories 271 and the one or more disks 272 may comprise hardware storage devices. The one or more processors 270 may comprise a processing system.

The software-level components may include software applications and computer programs. The cache controller 291, the cache sampling engine 244, and/or the hot/cold memory detection engine 245 may be stored or implemented using hardware, software, or a combination of hardware and software. In some cases, the software-level components are run using a dedicated hardware server. In other cases, the software-level components may be run using a virtual machine or containerized environment running on a plurality of machines. In various embodiments, the software-level components may be run from the cloud (e.g., the software-level components may be deployed using a cloud-based compute and storage infrastructure).

As depicted in FIG. 2B, the software-level components may also include virtualization layer processes, such as virtual machine 273, hypervisor 274, container engine 275, and host operating system 276. The hypervisor 274 may comprise a native hypervisor (or bare-metal hypervisor) or a hosted hypervisor (or type 2 hypervisor). The hypervisor 274 may provide a virtual operating platform for running one or more virtual machines, such as virtual machine 273. A hypervisor may comprise software that creates and runs virtual machine instances. Virtual machine 273 may include a plurality of virtual hardware devices, such as a virtual processor, a virtual memory, and a virtual disk. The virtual machine 273 may include a guest operating system that has the capability to run one or more software applications. The virtual machine 273 may run the host operation system 276 upon which the container engine 275 may run.

The container engine 275 may run on top of the host operating system 276 in order to run multiple isolated instances (or containers) on the same operating system kernel of the host operating system 276. Containers may facilitate virtualization at the operating system level and may provide a virtualized environment for running applications and their dependencies. Containerized applications may comprise applications that run within an isolated runtime environment (or container). The container engine 275 may acquire a container image and convert the container image into running processes. In some cases, the container engine 275 may group containers that make up an application into logical units (or pods). A pod may contain one or more containers and all containers in a pod may run on the same node in a cluster. Each pod may serve as a deployment unit for the cluster. Each pod may run a single instance of an application.

In some embodiments, the cache sampling engine 244 determines an initial set of cache lines to sample and then determines additional cache lines to be sampled based on aggregated access notifications. In some embodiments, the hot/cold memory detection engine 245 detects a first set of cold pages that are stored within a cache memory that are infrequently accessed (e.g., haven't been accessed within the past 500 ms) and a second set of hot pages that are stored within the cache memory that are frequently accessed (e.g., that have been accessed more than once in the past 500 ms). The cache controller 291 may move data between different caches within the one or more caches 292.

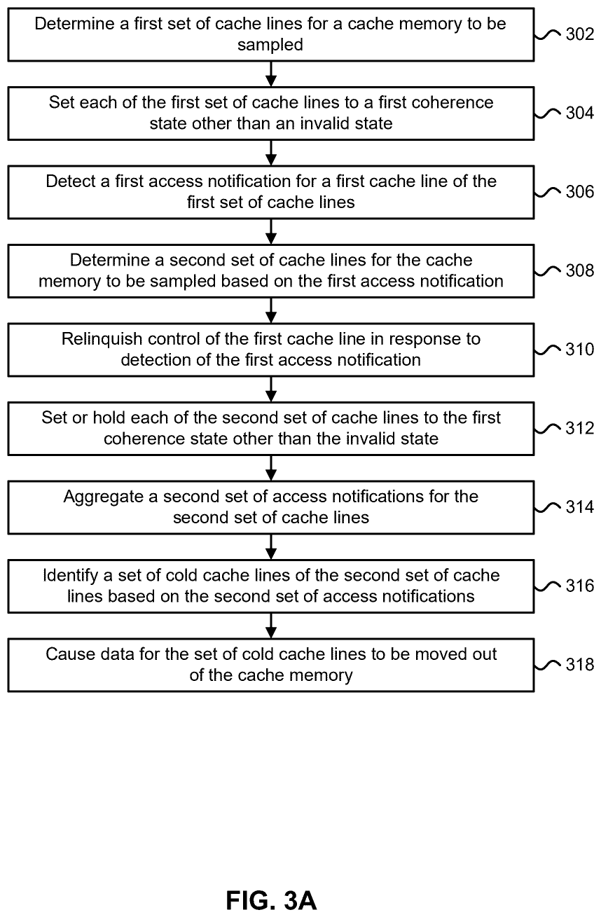

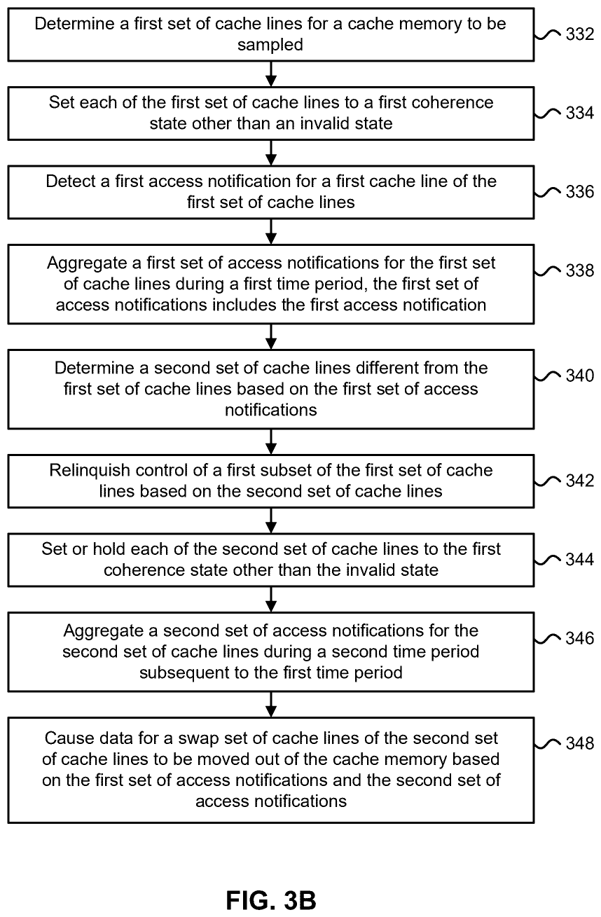

FIG. 3A depicts a flowchart describing one embodiment of a process for observing memory accesses using a cache coherence mechanism. In one embodiment, the process of FIG. 3A is performed using a computing system, such as the computing system 100 in FIG. 2A. In another embodiment, the process of FIG. 3A is performed using a cache controller, such as the cache controller 291 in FIG. 2B, or a cache sampling engine, such as the cache sampling engine 244 in FIG. 2B.

In step 302, a first set of cache lines for a cache memory to be sampled are determined. In one embodiment, the first set of cache lines corresponds to cache lines 161 and 165 in FIG. 1B. In step 304, each cache line of the first set of cache lines is set to a first coherence state other than an invalid state. In one example, the first coherence state comprises an exclusive state or a shared state of the MESI protocol states. In step 306, a first access notification for a first cache line of the first set of cache lines is detected. In one example, the memory controller 108 of FIG. 1B receives an access notification if one of the one or more cores 102 in FIG. 1B attempts to access the first cache line.

In step 308, a second set of cache lines for the cache memory to be sampled is determined based on the first access notification. In one embodiment, the second set of cache lines corresponds to cache lines 163, 165, and 167 in FIG. 1C.

In step 310, control of the first cache line is relinquished in response to detection of the first access notification. In step 312, each cache line of the second set of cache lines is set to or held to the first coherence state. In step 314, a second set of access notifications for the second set of cache lines is aggregated. In one example, the memory controller 108 of FIG. 1C aggregates the received access notifications for the second set of cache lines over a sampling time period.

In step 316, a set of cold cache lines of the second set of cache lines is identified based on the second set of access notifications. In one example, the set of cold cache lines comprises each of the cache lines within the second set of cache lines that was accessed less than a threshold number of times (e.g., less than two times) during a sampling time period. In step 318, data for the set of cold cache lines is caused to be moved out of the cache memory. In one example, the memory controller 108 moves data associated with pages or cache blocks that are deemed cold to main memory.

FIG. 3B depicts a flowchart describing an alternative embodiment of a process for observing memory accesses using a cache coherence mechanism. In one embodiment, the process of FIG. 3B is performed using a computing system, such as the computing system 100 in FIG. 1A. In another embodiment, the process of FIG. 3B is performed using a cache controller, such as the cache controller 291 in FIG. 2B.

In step 332, a first set of cache lines for a cache memory to be sampled is determined. In step 334, each cache line of the first set of cache lines is set to a first coherence state other than an invalid state. In step 336, a first access notification for a first cache line of the first set of cache lines is detected. In step 338, a first set of access notifications for the first set of cache lines is aggregated during a first time period. The first set of access notifications includes the first access notification. In step 340, a second set of cache lines different from the first set of cache lines is determined based on the first set of access notifications. In one example, the first set of cache lines corresponds to cache lines 161 and 165 in FIG. 1B and the second set of cache lines corresponds to cache lines 163, 165, and 167 in FIG. 1C.

In step 342, control of a first subset of the first set of cache lines is relinquished based on the second set of cache lines. In one example, the first subset of the first set of cache lines is released from sampling due to infrequent access. The first subset of the first set of cache lines may comprise all the cache lines of the first set of cache lines that are not in the second set of cache lines.

In step 344, each cache line of the second set of cache lines is set to or held to the first coherence state. In step 346, a second set of access notifications for the second set of cache lines is aggregated during a second time period subsequent to the first time period. In step 348, data for a swap set of cache lines of the second set of cache lines is caused to be moved out of the cache memory based on the first set of access notifications and the second set of access notifications. In one example, the memory controller 108 of FIG. 1C moves data associated with pages or cache blocks that are deemed cold to main memory.

At least one embodiment of the disclosed technology includes determining a first set of cache lines for a cache memory to be sampled; setting each cache line of the first set of cache lines to a first coherence state other than an invalid state; detecting a first access notification for a first cache line of the first set of cache lines; determining a second set of cache lines for the cache memory different from the first set of cache lines in response to detection of the first access notification; setting each cache line of the second set of cache lines to the first coherence state; aggregating a second set of access notifications for the second set of cache lines; identifying a set of cold cache lines of the second set of cache lines based on the second set of access notifications; and causing data for the set of cold cache lines to be moved out of the cache memory.

In some cases, the method further comprises relinquishing control of the first cache line in response to detection of the first access notification.

In some cases, the determining the second set of cache lines for the cache memory includes identifying a plurality of additional cache lines within a threshold distance of the first cache line.

In some cases, the aggregating the second set of access notifications for the second set of cache lines occurs over a sampling time period, and the identifying the set of cold cache lines of the second set of cache lines includes identifying the set of cold cache lines based on the number of access notifications for the set of cold cache lines that occurred during the sampling time period. The sampling time period may be set based on a number of processing units in communication with the cache memory.

At least one embodiment of the disclosed technology includes a plurality of cores; a cache coherence device; and a plurality of cache memories in communication with the plurality of cores and the cache coherence device, the cache coherence device configured to determine a first set of cache lines for a cache memory of the plurality of cache memories to be sampled; set each cache line of the first set of cache lines to a first coherence state; detect a first access notification for a first cache line of the first set of cache lines subsequent to setting the first cache line to the first coherence state; determine a second set of cache lines for the cache memory different from the first set of cache lines based on the first access notification; set each cache line of the second set of cache lines to the first coherence state; aggregate a second set of access notifications for the second set of cache lines; and cause data to be moved out of the cache memory based on the second set of access notifications.

In some cases, the cache coherence device is configured to identify a set of cold cache lines of the second set of cache lines based on the second set of access notifications and cause data for the set of cold cache lines to be moved out of the cache memory.

In some cases, the cache coherence device is configured to identify a plurality of additional cache lines within a threshold distance of the first cache line, the second set of cache lines includes the plurality of additional cache lines.

In some cases, the cache coherence device is configured to aggregate the second set of access notifications for the second set of cache lines over a sampling time period, and identify a set of cold cache lines based on the number of access notifications for the set of cold cache lines that occurred during the sampling time period.

At least one embodiment of the disclosed technology includes determining a first set of cache lines for a cache memory to be sampled; setting each cache line of the first set of cache lines to a first coherence state; aggregating a first set of access notifications for the first set of cache lines during a first time period; determining a second set of cache lines different from the first set of cache lines based on the first set of access notifications; relinquishing control of a first subset of the first set of cache lines; ensuring that each cache line of the second set of cache lines has been set to the first coherent state; aggregating a second set of access notifications for the second set of cache lines during a second time period subsequent to the first time period; and causing data to be moved out of the cache memory based on the first set of access notifications and the second set of access notifications.

In some cases, the method further comprises identifying a set of cold cache lines out of the second set of cache lines based on a number of access notifications for the set of cold cache lines that occurred during the first time period and the second time period; and causing data for the set of cold cache lines to be moved out of the cache memory.

The disclosed technology may be described in the context of computer-executable instructions being executed by a computer or processor. The computer-executable instructions may correspond with portions of computer program code, routines, programs, objects, software components, data structures, or other types of computer-related structures that may be used to perform processes using a computer. Computer program code used for implementing various operations or aspects of the disclosed technology may be developed using one or more programming languages, including an object oriented programming language such as Java or C++, a function programming language such as Lisp, a procedural programming language such as the “C” programming language or Visual Basic, or a dynamic programming language such as Python or JavaScript. In some cases, computer program code or machine-level instructions derived from the computer program code may execute entirely on an end user's computer, partly on an end user's computer, partly on an end user's computer and partly on a remote computer, or entirely on a remote computer or server.

The flowcharts and block diagrams in the figures provide illustrations of the architecture, functionality, and operation of possible implementations of systems, methods, and computer program products according to various aspects of the disclosed technology. In this regard, each step in a flowchart may correspond with a program module or portion of computer program code, which may comprise one or more computer-executable instructions for implementing the specified functionality. In some implementations, the functionality noted within a step may occur out of the order noted in the figures. For example, two steps shown in succession may, in fact, be executed substantially concurrently, or the steps may sometimes be executed in the reverse order, depending upon the functionality involved. In some implementations, steps may be omitted and other steps added without departing from the spirit and scope of the present subject matter. In some implementations, the functionality noted within a step may be implemented using hardware, software, or a combination of hardware and software. As examples, the hardware may include microcontrollers, microprocessors, field programmable gate arrays (FPGAs), and electronic circuitry.

For purposes of this document, the term “processor” may refer to a real hardware processor or a virtual processor, unless expressly stated otherwise. A virtual machine may include one or more virtual hardware devices, such as a virtual processor and a virtual memory in communication with the virtual processor.

For purposes of this document, a first layer may be over or above a second layer if zero, one, or more intervening layers are between the first layer and the second layer.

Two devices may be “in communication” if they are directly or indirectly connected so that they can communicate electronic signals between them.

For purposes of this document, it should be noted that the dimensions of the various features depicted in the figures may not necessarily be drawn to scale.

For purposes of this document, reference in the specification to “an embodiment,” “one embodiment,” “some embodiments,” “another embodiment,” and other variations thereof may be used to describe various features, functions, or structures that are included in at least one or more embodiments and do not necessarily refer to the same embodiment unless the context clearly dictates otherwise.

For purposes of this document, a connection may be a direct connection or an indirect connection (e.g., via another part). In some cases, when an element is referred to as being connected or coupled to another element, the element may be directly connected to the other element or indirectly connected to the other element via intervening elements. When an element is referred to as being directly connected to another element, then there are no intervening elements between the element and the other element.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify or distinguish separate objects.

For purposes of this document, the term “set” of objects may refer to a “set” of one or more of the objects.

For purposes of this document, the phrases “a first object corresponds with a second object” and “a first object corresponds to a second object” may refer to the first object and the second object being equivalent, analogous, or related in character or function.

For purposes of this document, the term “or” should be interpreted in the conjunctive and the disjunctive. A list of items linked with the conjunction “or” should not be read as requiring mutual exclusivity among the items, but rather should be read as “and/or” unless expressly stated otherwise. The terms “at least one,” “one or more,” and “and/or,” as used herein, are open-ended expressions that are both conjunctive and disjunctive in operation. The phrase “A and/or B” covers embodiments having element A alone, element B alone, or elements A and B taken together. The phrase “at least one of A, B, and C” covers embodiments having element A alone, element B alone, element C alone, elements A and B together, elements A and C together, elements B and C together, or elements A, B, and C together. The indefinite articles “a” and “an,” as used herein, should typically be interpreted to mean “at least one” or “one or more,” unless expressly stated otherwise.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for utilizing observation of memory accesses, comprising:
determining a first set of cache lines for a cache memory to be sampled;
setting each cache line of the first set of cache lines to a first coherence state other than an invalid state, the setting each cache line of the first set of cache lines to the first coherence state includes setting each cache line of the first set of cache lines to the first coherence state without writing data to a data portion of the first set of cache lines or storing data from the data portion of the first set of cache lines;
detecting a first access notification for a first cache line of the first set of cache lines;
determining a second set of cache lines for the cache memory different from the first set of cache lines in response to detection of the first access notification;
setting each cache line of the second set of cache lines to the first coherence state;
aggregating a second set of access notifications for the second set of cache lines;
identifying a set of cold cache lines of the second set of cache lines based on the second set of access notifications; and
causing data for the set of cold cache lines to be moved out of the cache memory.

2. The method of claim 1, further comprising:
relinquishing control of the first cache line in response to detection of the first access notification without writing data to a data portion of the first cache line or storing data from the data portion of the first cache line.

3. The method of claim 1, wherein:
the first coherence state comprises an exclusive state.

4. The method of claim 1, wherein:
the determining the second set of cache lines for the cache memory includes identifying a plurality of additional cache lines within a threshold distance of the first cache line.

5. The method of claim 4, wherein:
the threshold distance comprises ten cache lines.

6. The method of claim 1, wherein:
the aggregating the second set of access notifications for the second set of cache lines occurs over a sampling time period.

7. The method of claim 6, wherein:
the identifying the set of cold cache lines of the second set of cache lines includes identifying the set of cold cache lines based on the number of access notifications for the set of cold cache lines that occurred during the sampling time period.

8. The method of claim 6, wherein:
the sampling time period is set based on a number of processing units in communication with the cache memory.

9. The method of claim 1, wherein:
the cache memory comprises an SRAM.

10. The method of claim 1, wherein:
the causing data for the set of cold cache lines to be moved out of the cache memory includes transferring the data for the set of cold cache lines from the cache memory to another cache memory.

11. A computing system, comprising:
a plurality of cores;
a cache coherence device; and
a plurality of cache memories in communication with the plurality of cores and the cache coherence device, the cache coherence device configured to: <determine a first set of cache lines for a cache memory of the plurality of cache memories to be sampled;
set each cache line of the first set of cache lines to a first coherence state without writing data to a data portion of the first set of cache lines or storing data from the data portion of the first set of cache lines;
detect a first access notification for a first cache line of the first set of cache lines subsequent to setting the first cache line to the first coherence state;
determine a second set of cache lines for the cache memory different from the first set of cache lines based on the first access notification;
set each cache line of the second set of cache lines to the first coherence state;
aggregate a second set of access notifications for the second set of cache lines; and
cause data to be moved out of the cache memory based on the second set of access notifications.

12. The computing system of claim 11, wherein:
the cache coherence device configured to identify a set of cold cache lines of the second set of cache lines based on the second set of access notifications and cause data for the set of cold cache lines to be moved out of the cache memory.

13. The computing system of claim 11, wherein:
the cache coherence device configured to relinquish control of the first cache line without writing data to a data portion of the first cache line or storing data from the data portion of the first cache line in response to detection of the first access notification.

14. The computing system of claim 11, wherein:
the first coherence state comprises a shared state.

15. The computing system of claim 11, wherein:
the cache coherence device configured to identify a plurality of additional cache lines within a threshold distance of the first cache line, the second set of cache lines includes the plurality of additional cache lines.

16. The computing system of claim 11, wherein:
the cache coherence device configured to aggregate the second set of access notifications for the second set of cache lines over a sampling time period.

17. The computing system of claim 16, wherein:
the cache coherence device configured to identify a set of cold cache lines based on the number of access notifications for the set of cold cache lines that occurred during the sampling time period.

18. The computing system of claim 16, wherein:
the sampling time period is set based on a size of the cache memory.

19. A method for utilizing observation of memory accesses, comprising:
determining a first set of cache lines for a cache memory to be sampled;
setting each cache line of the first set of cache lines to a first coherence state without writing data to a data portion of the first set of cache lines or storing data from the data portion of the first set of cache lines;
aggregating a first set of access notifications for the first set of cache lines during a first time period;
determining a second set of cache lines different from the first set of cache lines based on the first set of access notifications;
relinquishing control of a first subset of the first set of cache lines;
ensuring that each cache line of the second set of cache lines has been set to the first coherent state;
aggregating a second set of access notifications for the second set of cache lines during a second time period subsequent to the first time period; and
causing data to be moved out of the cache memory based on the first set of access notifications and the second set of access notifications.

20. The method of claim 19, further comprising:
identifying a set of cold cache lines out of the second set of cache lines based on a number of access notifications for the set of cold cache lines that occurred during the first time period and the second time period; and
causing data for the set of cold cache lines to be moved out of the cache memory.
